(19) United States
(12) Patent Application Publication
(10) Pub. No.: US 2025/0206463 A1
(43) Pub. Date: Jun. 26, 2025

(54) SYSTEMS, METHODS, AND DEVICES FOR GROUND MANEUVERING OF AIRCRAFT

(71) Applicant: SUPERNAL, LLC, Washington, DC (US)

(72) Inventors: Matthew Phillip Aralis, Redwood City, CA (US); Christian Moreno, Lakewood, CA (US); Alexander Pozzi, Carlsbad, CA (US)

(21) Appl. No.: 18/847,100

(22) PCT Filed: Mar. 15, 2023
(86) PCT No.: PCT/US2023/064431

§ 371 Date: Sep. 13, 2024

Related U.S. Application Data
(60) Provisional application No. 63/269,436, filed on Mar. 16, 2022.

(51) Int. Cl. B64F 1/228; B64F 1/00; B64F 1/12; B64F 1/20; B64F 1/227; B64F 1/35

(52) U.S. Cl. CPC B64F 1/228; B64F 1/007; B64F 1/125; B64F 1/20; B64F 1/227; B64F 1/352

(57) ABSTRACT

Exemplary disclosed embodiments include systems, methods, and devices for a ground maneuvering system for aircraft. The systems, methods, and devices may include a ground maneuvering system including at least one processor in communication with at least one sensor and at least one maneuvering vehicle. The at least one maneuvering vehicle includes one or more processors in communication with one or more sensors. The one or more processors can be configured to sense, using the one or more sensors, an area associated with a plurality of areas, to determine a location within area, or to maneuver the maneuvering vehicle to the location. The maneuvering vehicle may also include a movement system for maneuvering the maneuvering vehicle in or around the plurality of areas, and a platform configured for an aircraft.

### RELATED APPLICATIONS

This application claims the benefit under 35 U.S.C. § 119 (e) to U.S. Provisional Application No. 63/269,436 filed Mar. 16, 2022, which application is incorporated by reference herein in its entirety.

### FIELD OF THE DISCLOSURE

The present disclosure relates to systems, methods, and devices for a ground maneuvering system for aircraft.

### BACKGROUND

Current systems and approaches for maneuvering aircraft are limited by numerous factors and may not be sufficient for the needs of a takeoff and landing area having a number of aircraft. For example, tug systems are often used to maneuver aircraft on the ground, but current tugs must manually latched onto an aircraft through direct controls or attachments and, after being attached, require that they be driven or maneuvered by an operator to move the aircraft. For larger aircraft, a number of separate systems are often used to service an aircraft and/or pull an aircraft into a position, for example a parking position. But, for a large airfield with multiple incoming and outgoing aircraft, these known systems may struggle to maintain timely airport operations due to, for example, insufficient resources, such as manpower and time, and/or an insufficient number of tugs, available to service every aircraft at the time that such service is required. Similarly, for small airfields, the operability and maneuverability of known systems may limit the ability to maneuver aircraft to optimal areas to preserve a landing area for other incoming aircraft.

As an alternative to using tugs, some aircraft are maneuvered manually by a pilot. This approach may also be insufficient because, for example, their maneuverability may be limited due to limited pilot visibility during ground operations and/or limited movement capability (e.g., large turning radii, limited lateral travel) or no movement capability (e.g., helicopters may land on skids and not have wheels) of the aircraft.

With respect to helicopters and vertical take-off and landing craft, limited maneuverability has even greater import. Indeed, such aircraft may not be equipped with wheels or other readily available movement apparatus. They also have the ability to land in a large variety of locations (e.g., parking lot, pavement, a relatively flat area), which often do not have any ground support functionality. Further, such aircraft may use a small pad or a small area for landing, and if not moved from that landing area, may prevent other craft from using the same landing area.

Disclosed herein is an improved system for maneuvering a vehicle and servicing aircraft that alleviates or eliminates the problems discussed above. For example, improvements are possible by combining the capabilities of a motorized maneuvering vehicle and the capabilities of servicing or moving an aircraft. It is also desirable to improve known systems by using autonomous or controllable systems so that vehicles may be systematically and reliably moved as needed around a landing area. It is further desirable that improved systems can determine whether an area is clear for landing or take-off.

### SUMMARY

In the following description, certain aspects and embodiments will become evident. It is contemplated that the aspects and embodiments, in their broadest sense, could be practiced without having one or more features of these aspects and embodiments. It is also contemplated that these aspects and embodiments are merely exemplary.

Exemplary disclosed embodiments include systems, methods, and devices for a ground maneuvering system for aircraft. A ground maneuvering system may include a maneuvering vehicle comprising one or more processors. The one or more processors may sense, via a sensor mounted to a frame of the maneuvering vehicle, an aircraft landing area. The one or more processors may determine a first location, wherein the first location is based on the aircraft landing area. The one or more processors may move the maneuvering vehicle to the determined first location. The one or more processors may determine a second location, wherein the second location is based on a parking area. The maneuvering vehicle may comprise a power source, configured to power the system. The maneuvering vehicle may comprise a landing platform, configured to receive a landing aircraft.

Exemplary disclosed embodiments include systems, methods, and devices for a maneuvering vehicle including one or more processors in communication with one or more sensors, a movement system including a set of wheels, a power source configured to power the maneuvering vehicle, and a landing platform configured to receive an aircraft. The movement system may comprise a propulsor. The propulsor may be configured to move the maneuvering vehicle from one location or area to another.

In some embodiments, the maneuvering vehicle may include a navigation feature, the navigation feature including at least one of a marker, a reflector, a reflective paint, a beacon, or a wireless communication system, wherein the navigation feature is configured to aid the aircraft in landing. In some embodiments, the maneuvering vehicle may include a charging system, wherein the charging system is configured to charge the aircraft.

In some embodiments, the maneuvering vehicle may include the one or more processors further configured to sense, via a sensor, an aircraft landing area, determine a first location, wherein the first location is based on the aircraft landing area, move the maneuvering vehicle to the determined first location, determine a second location, wherein the second location is based on a parking area, and move the maneuvering vehicle to the determined second location. In some embodiments, the maneuvering vehicle may include an attachment arm configured to attach to a landing gear of an aircraft. In some embodiments, the maneuvering vehicle may include a sensor configured to determine whether an attachment arm has attached to a landing gear.

In some embodiments, the maneuvering vehicle may include a navigation system configured to determine where to move the aircraft. In some embodiments, the navigation system is further configured to move the aircraft to a parking area or a takeoff area. In some embodiments, the maneuvering vehicle includes a platform. In some embodiments, the landing platform is configured to be used while the maneuvering vehicle in motion.

An aircraft movement system including at least one receiving vehicle including: a movement system, a platform, and a sensor configured to determine whether the platform is in a disembarkation position relative to an aircraft.

In some embodiments, the maneuvering vehicle may include one or more of a charger, HVAC, battery cooling, or auxiliary power.

In some embodiments, the navigation system is further configured to move the aircraft to a parking area or a takeoff area.

In some embodiments, the platform is further configured to move to mate to a door of the aircraft via an actuator when the landing gear is locked.

In some embodiments, the platform is further configured to be on both sides of the aircraft to accommodate loading and unloading from both sides of the aircraft simultaneously.

In some embodiments, the receiving vehicle is configured to install a brake configured to keep the aircraft from moving when stopped.

In some embodiments, the maneuvering vehicle may include at least one sensor, wherein the at least one sensor includes one or more of an infrared sensor, a lidar sensor, and a radar sensor.

In some embodiments, the sensor is configured to detect an orientation of a stationary aircraft, wherein a processor is in communication with the sensor and the processor is configured to determine an approach path such that the landing gear aligns with the attachment arm and a door of the aircraft aligns with the receiving stair.

Exemplary disclosed embodiments include systems, methods, and devices for an aircraft coordination system including a navigation system configured to send signals to direct one or more moving platforms, one or more sensors configured to detect a position of a landed aircraft and one or more processors configured to: determine where to move the one or more moving platforms to receive the aircraft, determine where to move the one or more moving platforms to park the aircraft.

In some embodiments, the one or more processors are further configured to send a signal to an actuating arm of the one or more moving platforms to attach to the aircraft.

It is to be understood that both the foregoing general description and the following detailed description are exemplary and explanatory only and are not restrictive of the invention. The accompanying drawings, which are incorporated in and constitute a part of this specification, illustrate several exemplary embodiments and together with the description, serve to outline principles of the exemplary embodiments.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1A illustrates an exemplary ground maneuvering system for aircraft, consistent with disclosed embodiments.

FIG. 1B illustrates an exemplary maneuvering vehicle moving to a location within an aircraft landing area, consistent with disclosed embodiments.

FIG. 1C illustrates an exemplary maneuvering vehicle at a location within an aircraft landing area, consistent with disclosed embodiments.

FIG. 2A illustrates an exemplary maneuvering vehicle moving to a location within a parking area, consistent with disclosed embodiments.

FIG. 2B illustrates an exemplary maneuvering vehicle at a location within a parking area, consistent with disclosed embodiments.

FIG. 3A illustrates an exemplary maneuvering vehicle moving to a location within a takeoff area, consistent with disclosed embodiments.

FIG. 3B illustrates an exemplary maneuvering vehicle moving at a location within a takeoff area, consistent with disclosed embodiments.

FIG. 4 illustrates an exemplary maneuvering vehicle with navigation features, consistent with disclosed embodiments.

FIG. 5 illustrates an exemplary maneuvering vehicle, consistent with disclosed embodiments.

FIG. 6 illustrates an exemplary ground maneuvering system, consistent with disclosed embodiments.

FIG. 7 illustrates an exemplary ground maneuvering system, consistent with disclosed embodiments.

FIG. 8 illustrates an exemplary command system of one or more multiple maneuvering vehicles.

FIG. 9A illustrates an exemplary vehicle, consistent with disclosed embodiments.

FIG. 9B illustrates an exemplary maneuvering vehicle, consistent with disclosed embodiments.

FIG. 10 illustrates a bottom view of an exemplary maneuvering vehicle, consistent with disclosed embodiments.

### DESCRIPTION OF EXEMPLARY EMBODIMENTS

Reference will now be made in detail to exemplary embodiments, shown in the accompanying drawings.

Exemplary disclosed embodiments include systems, methods, and devices for ground maneuvering for aircraft. Ground maneuvering system may refer to a system that steers, guides, drives, pilots, directs, or any other similar direction of motion of a maneuvering vehicle on a surface, such as a ground. The maneuvering vehicle may move to, approach, move away from, or move with, an aircraft. Disclosed embodiments may provide benefits such as moving aircraft, either by tugging an aircraft or with an aircraft on the maneuvering vehicle, without manual inputs or with limited manual inputs. For example, the maneuvering vehicle or a ground maneuvering system may move to allow room for other aircraft, to clear a landing area, to charge, to unload, to park, or to taxi. The maneuvering vehicle or the ground maneuvering system may be configured to sense where to move. Maneuvering vehicles consistent with disclosed embodiments may be further configured to alleviate ground traffic by providing charging, loading/unloading systems, or other accessory attachments for aircraft. Maneuvering vehicles may be able to move laterally to move aircraft more easily. Maneuvering vehicles may include beacons or other landing navigation systems for receiving aircraft. Maneuvering vehicles may be individually autonomous and sense where to move at determined times or the ground maneuvering system may direct maneuvering vehicles when and/or where to move to alleviate traffic and to clear high volume areas.

In some embodiments, the system may include a maneuvering vehicle comprising one or more processors. Maneuvering vehicle may refer to an object used for transportation that is steered, guided, driven, piloted, directed, or controlled any other similar way. One or more processors may refer to at least one of a central processing unit (CPU), a central processor, a mainframe, a microprocessor, or a similar circuit that performs calculations that run a computer or computing device. Non-limiting examples of one or more processors may refer to a processor associated with an aircraft, a processor associated with a sensor, a processor associated with a handheld electronic device, or a combination of processors. In some embodiments, the maneuvering vehicle system may be controlled by the one or more processors. In some embodiments, the one or more processors may receive a user input. User input may refer to any information or data sent to a computer from a user. The user may use an input device. An input device may be any physical device that allows the user to provide one or more inputs. The data or information provided may be in a digital format and/or in an analog format. Non-limiting examples of input devices may include a button, a key, a keyboard, a computer mouse, a touchpad, a touchscreen, a joystick, or another mechanism from which input may be received. For example, the user may provide one or more inputs by pressing one or more keys of the keyboard. In some embodiments, the maneuvering vehicle system may be controlled by a monitoring network comprising one or more processors. Monitoring network may refer to a system that monitors, watches, or oversees a computer network with one or more computer networking components. For example, the monitoring network may include one or more processors and one or more maneuvering vehicles comprising one or more processors.

In some embodiments, the maneuvering vehicle may include a movement system comprising three or more wheels mounted to the frame. A movement system may refer to a system for motion, maneuvering, or any other similar act of changing physical location or position. One example of the movement system may include three or more wheels mounted to a frame. In one example, one of the three or more wheels is mounted to the front of the frame and two of the three or more wheels is mounted to the back of the frame. In another example, the three or more wheels mounted to the frame is four wheels. In this example, two of the four wheels may be located at the front of the frame wherein one wheel is on a left side of the frame and one wheel is on a right side of the frame. Further, the other two of the four wheels may be located at the back of the frame wherein one wheel is on the left side of the frame and one wheel is on the right side of the frame. Another example of the movement system may include a set of toothed wheels, wherein the set of toothed wheels connect to a continuous band of plates, wherein the continuous band of plates forms a closed chain and the continuous band of plates are jointed by a hinge. In this example, the set of toothed wheels may connect to the continuous band of plates via corresponding grooves of the continuous band of plates. The continuous band of plates may be tread plates or track plates.

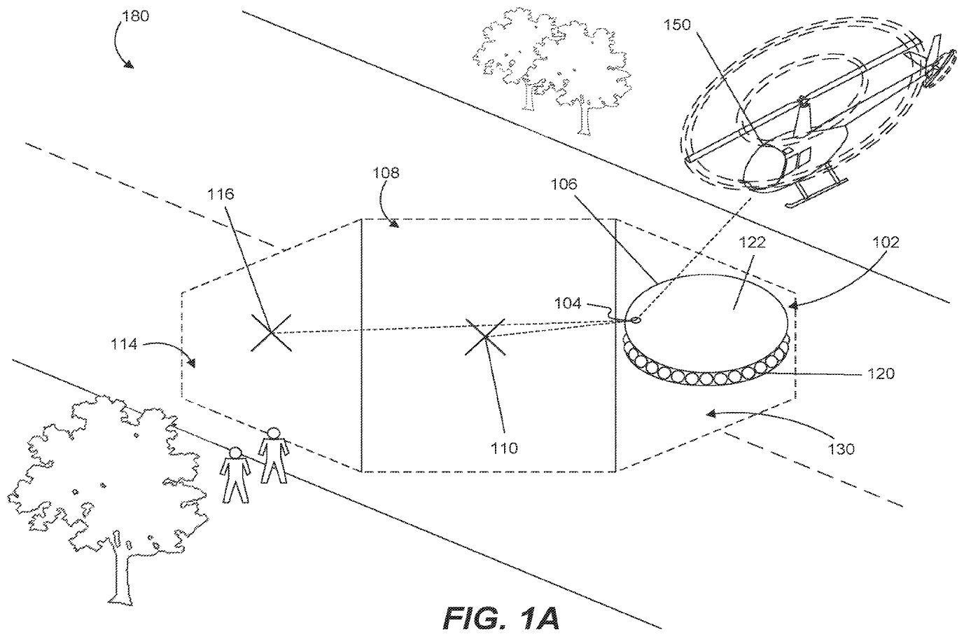

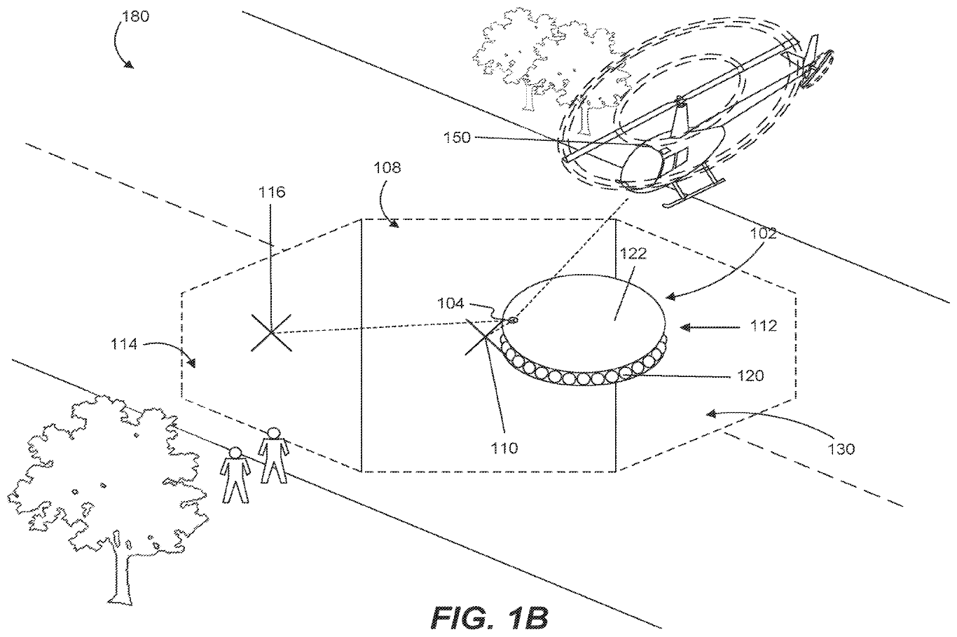

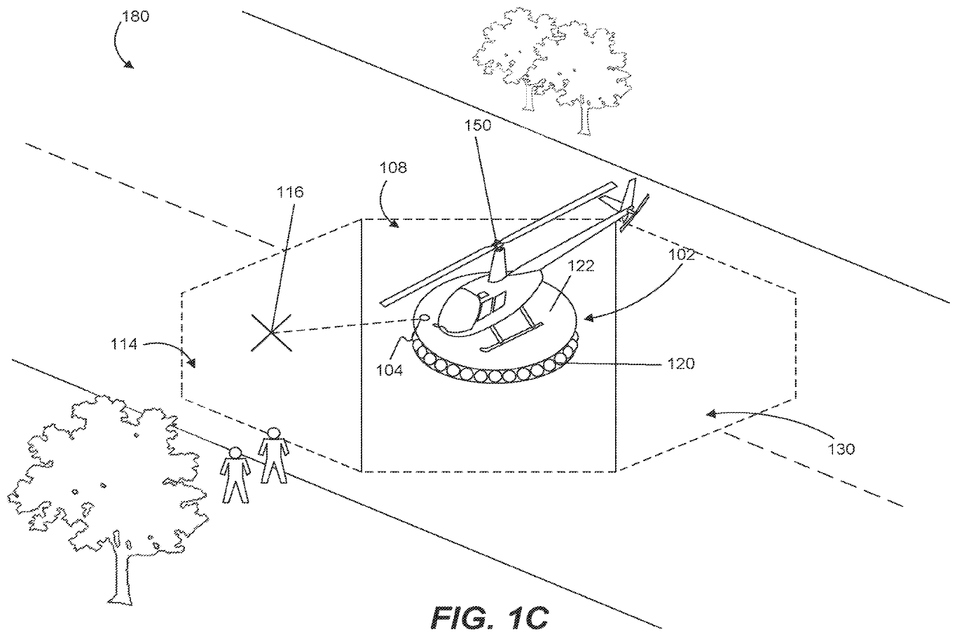

FIG. 1A illustrates an exemplary ground maneuvering system for aircraft, consistent with disclosed embodiments. FIG. 1A illustrates ground 180, a maneuvering vehicle 102, and an aircraft 150. Additionally, FIG. 1A illustrates a landing area 108, a parking area 114, and a takeoff area 130. Moreover, FIG. 1A illustrates a first location 110 and a second location 116. It will be understood that the first and second location 110, 116 need not be different areas. First and second locations could share the same surface or could have different surfaces and/or be marked differently to indicate a difference of intended use. It will also be understood that additional locations exist.

Aircraft 150 may be an aerial, floating, soaring, hovering, airborne, aeronautical aircraft, airplane, plane, spacecraft, vessel, or other vehicle moving or able to move through air. Non-limiting examples may include a helicopter, an airship, a hot air balloon, an unmanned aerial vehicle, a vertical takeoff craft, spacecraft, or a drone. Aircraft 150 may include wheels or landing rails. Aircraft 150 may include a tricycle landing gear or conventional landing gear.

Maneuvering vehicle 102 may include one or more processors, memory, a movement system 120, a sensor 104, and a frame 106. In some embodiments, maneuvering vehicle 102 may include a landing platform 122. In some embodiments, landing platform 122 may be circular and large enough for aircraft 150 to land and take off from. In some embodiments, movement system 120 can include a set of toothed wheels. The set of toothed wheels can connect to a continuous band of plates. The continuous band of plates can form a closed chain. In some examples, the continuous band of plates may be jointed by a hinge. In some embodiments, the movement system 120 may include a track, or steerable wheel. In some embodiments, movement system 120 may be configured to move maneuvering vehicle 102 to a first location 110. In some embodiments, movement system 120 may be configured to move maneuvering vehicle 102 to a second location 116. In some embodiments, movement system 120 may be configured to move maneuvering vehicle 102 between the first location 110 and the second location 116. It will be understood that movement system 120 can move maneuvering vehicle 102 to (or between) several locations. Movement system 120 may include the movement system may comprise a propulsor. The propulsor may be configured to move the maneuvering vehicle from one location or area to another.

In some embodiments, the maneuvering vehicle 102 may comprise a data cable such that information may be passed to and from the maneuvering vehicle 102. For example, the data cable may provide information on a movement of the maneuvering vehicle 102, an estimated time until arrival or estimated time of arrival, or ground weather conditions. In some embodiments, maneuvering vehicle 102 may receive commands from aircraft 150 through a data cable such as to halt movement or continue movement. In some embodiments, the maneuvering vehicle 102 can receiving commands to remotely control movement of the platform 122.

In some embodiments, maneuvering vehicle 102 may comprise a latch, magnet, or retaining clamp such that aircraft 150 is secured to maneuvering vehicle 102. In some embodiments, maneuvering vehicle 102 may comprise a latch, magnet, or retaining clamp such a wheel of aircraft 150 (not shown) cannot roll such that an aircraft is affixed to maneuvering vehicle 102 during movement of maneuvering vehicle 102. In some embodiments, the latch, magnet, or retaining clamp may operate automatically to secure aircraft 150 to maneuvering vehicle 102. In some embodiments, the latch, magnet, or retaining clamp of maneuvering vehicle 102 may be configured to operate on command from a communication system (e.g., radio or a signal over a common communication system) from aircraft 150 or on command from aircraft 150 through a data cable connection. In some embodiments, the maneuvering vehicle 102 may comprise a power source, configured to power the maneuvering vehicle. Power source may refer to a place or thing which energy comes or can be obtained from. Power may refer to supplying an object with energy. Non-limiting examples of power source may include a battery, a generator, an alternator, or an auxiliary power unit. In some embodiments, the maneuvering vehicle 102 may include a storage area for power sources, such as charged batteries. In some embodiments, power source of the aircraft 150 may be swappable or hot-swappable, to reduce downtime of the aircraft 150.

One or more actuators of the maneuvering vehicle 102 may be configured to remove a drained battery from aircraft 150. One or more actuators of the maneuvering vehicle 102 may be configured to insert a charged battery to aircraft 150. In some embodiments, a battery compartment of the aircraft 150 may be configured to open and/or an actuator may be configured to pull a battery from a slot inside aircraft 150. The actuator may be a linear and/or rotary actuator. The slot may include one or more connections (e.g., data, power, cooling) from a battery to aircraft 150. The aircraft 150 may open the compartment or the maneuvering vehicle 102 may be configured to open the compartment. In some embodiments, a battery compartment of the aircraft 150 may be configured to close around the battery (such as to form to an outer mold of aircraft 150 or an interior surface within aircraft 150), and/or an actuator may be configured to push a battery into a slot inside aircraft 150. The aircraft 150 may close the compartment or the maneuvering vehicle 102 may be configured to close the compartment. The aircraft 150 or the maneuvering vehicle 102 may be configured to open or close a latch, lock, clasp, or move another fastener to fix the battery within aircraft 150.

In some embodiments, the maneuvering vehicle 102's actuator may be configured to pull a drained battery from aircraft 150 and place it or pull it into a battery slot. The battery slot may include one or more connections (e.g., data, power, cooling) from a battery to the maneuvering vehicle 102. The battery may be charged or stored within the battery slot. A processor associated with maneuvering vehicle 102 may be configured to determine whether a battery within maneuvering vehicle 102 is charged so that it can determine whether the battery may be passed to an aircraft 150. A processor associated with aircraft 150 and/or maneuvering vehicle 102 may be configured to determine whether a battery within aircraft 150 is drained so that it can determine whether the battery may be passed to maneuvering vehicle 102.

In some embodiments, maneuvering vehicle 102 may comprise one or more processors that may be configured to provide the aircraft 150 with services including one or more of charging, HVAC, battery cooling, data transfer, and auxiliary power. The one or more processors may determine to provide services based on communication with aircraft 150. For example, the processor may consider a fueling state or any other state of aircraft 150 to determine if services should be provided. The processor may be configured to control one or more actuators, charging system, fueling system, HVAC system, power supply systems, or data management systems to facilitate providing the services. In some embodiments, charging and/or data transfer may occur through a wired or a wireless connection between the aircraft 150 and maneuvering vehicle 102. For example, maneuvering vehicle 102 may comprise a processor configured to download or upload data to the aircraft 150. Data may be related to flight planning, a software update, aircraft management data, continuous aircraft monitoring, battery state (e.g., charge, cooling), continuous flight data, or similar.

Sensor 104 may be configured to detect at least one of: a sound, an image, light, a signal, pressure, temperature, and/or gas. Non-limiting examples of a sensor may be an image sensor, a motion sensor, a temperature sensor, an infrared sensor, a light sensor, a chemical sensor, a biosensor, a monitoring sensor, and a noise sensor. It will be understood that maneuvering vehicle 102 may be include one or more sensors. Sensor 104 may be in communication with the one or more processor and/or memory of maneuvering vehicle 102.

Frame 106 may be a structure that surrounds or encloses the maneuvering vehicle 102. In some embodiments, sensor 104 may be attached to frame 106. In some embodiments, the maneuvering vehicle 102 may be configured to be used as a loading and unloading platform. For example, ramps, steps, or other disembarking systems may be attached to frame 106.

Landing platform 122 may be configured to receive aircraft 150. Landing platform 122 may refer to a surface on which aircrafts may land or takeoff from. Non-limiting examples of landing platforms may include a circular landing platform on top of the maneuvering vehicle 102 or a square landing platform on top of the maneuvering vehicle 102.

An area may refer to an extent of space or surface. Non-limiting examples of an area may be include a landing area, a waiting area, a passenger or cargo unloading area, a passenger or cargo loading area, an inside storage area, a takeoff area, or a parking area or any other area consistent with disclosed embodiments.

Landing area 108 may refer to an area where an aircraft lands. In non-limiting examples, a landing area may include a sufficiently flat space or surface, an empty space or surface, or a combination of a sufficiently flat and empty space or surface. Non-limiting examples of landing area may include a platform, a maneuvering vehicle, a tarmac, a part of the tarmac, a field, a part of the field, a pavement, a part of the pavement, a dirt area, or a part of the dirt area.

A parking area 114 may refer to an area where an aircraft is parked or stored, temporarily or for an extended period of time. In non-limiting examples, a parking area may include a sufficiently flat space or surface, an empty space or surface, or a combination of a sufficiently flat and empty space or surface. Non-limiting examples of parking area may include a platform, a maneuvering vehicle, a tarmac, a part of the tarmac, a field, a part of the field, a pavement, a part of the pavement, a dirt area, or a part of the dirt area.

A takeoff area 130 may refer to an area where an aircraft may takeoff. In non-limiting examples, a takeoff area may include a sufficiently flat space or surface, an empty space or surface, or a combination of a sufficiently flat and empty space or surface. Non-limiting examples of takeoff area may include a platform, a maneuvering vehicle, a tarmac, a part of the tarmac, a field, a part of the field, a pavement, a part of the pavement, a dirt area, or a part of the dirt area.

FIG. 1B illustrates an exemplary maneuvering vehicle moving to a location within an aircraft landing area, consistent with disclosed embodiments. FIG. 1B illustrates an exemplary maneuvering vehicle 102 moving, as depicted by arrow 112, to a location within landing area 108. In some embodiments, sensor 104 may be mounted to frame 106 of maneuvering vehicle 102 may sense aircraft 150 and landing area 108. For example, sensor 104 may be an image sensor 104 and capture images of aircraft 150 and landing area 108 over a period of time. Sensor 104 may check that landing area 108 does not contain any hazards or obstacles for landing an aircraft or determines the dimensions of landing area 108. Sensor 104 may sense aircraft 150 to determine aircraft 150 flight trajectory corresponding to where aircraft 150 will land within aircraft landing area 108. The one or more processors may determine the first location 110, based on the flight trajectory, to be a location within the landing area 108. Maneuvering vehicle 102 may then move to the determined location so that the aircraft 150 lands accurately on the maneuvering vehicle 102. In this way, the aircraft 150 may not have to redirect its flight trajectory and can safely and accurately land on the maneuvering vehicle 102.

In some embodiments, the one or more processors may determine the first location 110 to be a center location of the middle of the tarmac. In some embodiments, the determination may be based on the sensor sensing the landing area 108 as a middle of a tarmac.

In some embodiments, the one or more processors may move the maneuvering vehicle 102 by a displacement of ten feet from a right side of a tarmac to the aircraft landing area 108. In some embodiments, moving the maneuvering vehicle 102 to the determined first location 110 to make measurements of a landing area 108, to check for obstacles, to check for hazards, to determine if the landing area 108 has the correct dimensions, or to learn any other information for a successful landing of an aircraft 150.

In some embodiments, the one or more processors may move the maneuvering vehicle 102 to the determined first location 110. Move may refer to a change of place, position, or state. Non-limiting examples of moving may include a rotation, a displacement, or a translation.

In some embodiments, the one or more processors may determine first location 110 to be a center location of aircraft landing area 108. For example, aircraft landing area 108 may be the middle of ground 180. In some embodiments, aircraft landing area 108 may be on a paved area, an area of ground, or similar. In some embodiments, this determination may be made based on sensor 104 sensing aircraft landing area 108 as a middle of ground 180.

FIG. 1B illustrates maneuvering vehicle 102 moving, as depicted by arrow 112, to first location 110. For example, the one or more processors may move 112 maneuvering vehicle 102 by a displacement of ten feet from a right side of ground 180 to the middle of ground 180. In some embodiments, first location 110 may be based on aircraft landing area 108.

FIG. 1C illustrates an exemplary maneuvering vehicle at a location within an aircraft landing area, consistent with disclosed embodiments FIG. 1C illustrates maneuvering vehicle 102 at first location 110. In this way, maneuvering vehicle 102 moved 112 to first location 110 because it is the center of aircraft landing area 108. In some embodiments, maneuvering vehicle 102 moved 112 to first location 110 based on the flight trajectory of aircraft 150.

In some embodiments, the one or more processors may determine a second location 116, wherein the second location 116 is based on a parking area 114. In some examples, the second location 116 may be the first location 110. Alternatively, the second location 116 may be a location different than the first location 110. In some embodiments, the second location 116 may be based on the first location 110. In some embodiments, the determination may be made based on the sensor 104 sensing the parking area 114 as a left side of a tarmac. The one or more processors may then determine the second location 116 to be the center location of the parking area 114.

In some embodiments, maneuvering vehicle 102 may include one or more processors in communication with one or more sensors. One or more sensors, such as sensor 104 mounted to a frame 106 of the maneuvering vehicle 102, can be configured to sense an aircraft landing area 108. The sensor 104 of the manuvering vehicle 102 may sense an outer bound of one or more locations related to the aircraft, such as a landing area, a take-off area, a transition area, or a parking area. Sensor 104 may be configured transmit sensed information via wired and/or wireless communication. Sensor 104 may send sensed information to a processor. In some embodiments, sensor 104 may be an image sensor that analyzes and/or compares images taken over a period of time to assess a situation or area. The image sensor may capture images of the aircraft landing area 108 continuously or periodically and compare the images to one another.

Sense may refer to a sensor detecting, finding, noticing, observing, recognizing or any other way a sensor can discover or identify the presence, existence, or change of an environment.

Non-limiting examples of a sensor sensing may include sensor that responds to an external stimulus. An external stimulus may be a change in the environment. Sensor may refer to a device, module, machine, or subsystem that senses an environment. In some embodiments, an image sensor may be a camera. Sound may refer to any vibration that propagates or transmits as an acoustic wave. Non-limiting examples of sound may include a loud sound, a soft sound, a medium sound, an infrasonic sound, a sonic sound, and an ultrasonic sound. Image may refer to a representation or artifact that depicts visual perception. Non-limiting examples of image may include a photograph or other two-dimensional picture. Light may refer to electromagnetic radiation. Non-limiting examples of light may include radio waves, microwaves, infrared, visible, ultraviolet, x-rays, and gamma rays. Signal may refer to anything that serves to indicate, warn, direct, command, or similar indicator. Non-limiting examples of signals may motion or auditory. Pressure may refer to an amount of force. Non-limiting examples of pressure may include air pressure, ambient air pressure, atmospheric pressure, and barometric pressure. For example, the one or more sensors may be an audio sensor that may detect sound waves and convert the sound waves into electrical signals. The one or more sensors may be a positional sensor such as an accelerometer, gyroscope, geomagnetic field sensor, a range finder, radar sensors, or lidar sensors.

The processor may receive information from the one or more sensors to determine distance from the maneuvering vehicle to objects, position of the maneuvering vehicle in absolute or locally, or speed and/or acceleration of the maneuvering vehicle. In some embodiments, the processor may be configured to control the movement system in conjunction with sensor feedback to maintain a course of the maneuvering vehicle, to avoid other maneuvering vehicles, vehicles, aircraft, or buildings, to determine a position of the maneuvering vehicle, or to determine a next maneuvering vehicle position (e.g., based on speed and present position).

Mount may refer to a supporting member of the maneuvering vehicle. In some embodiments, objects may be attached to a mount to the maneuvering vehicle 102. Non-limiting examples of objects to be mounted may include sensors, charging systems, and support systems.

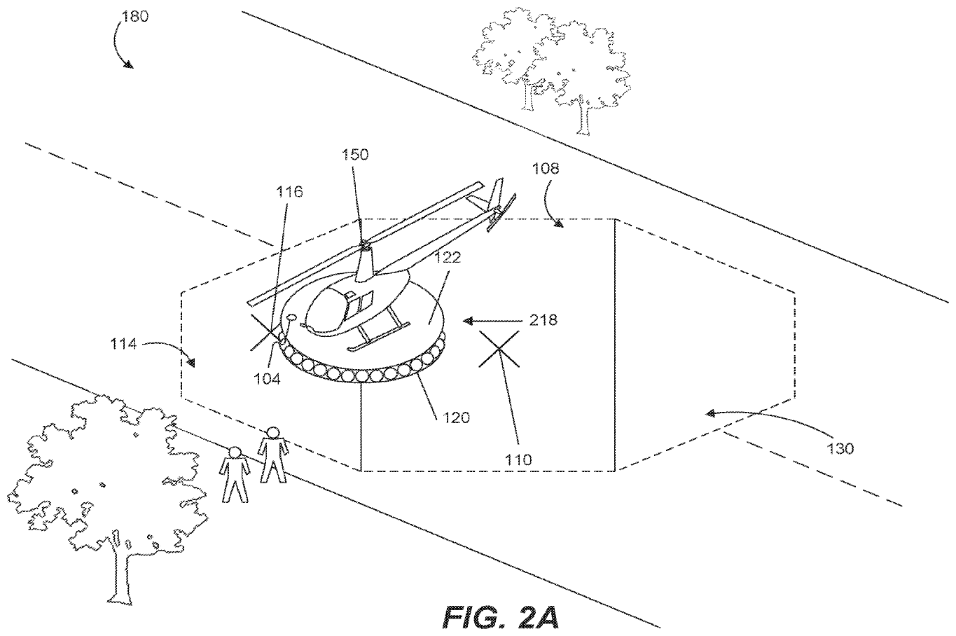

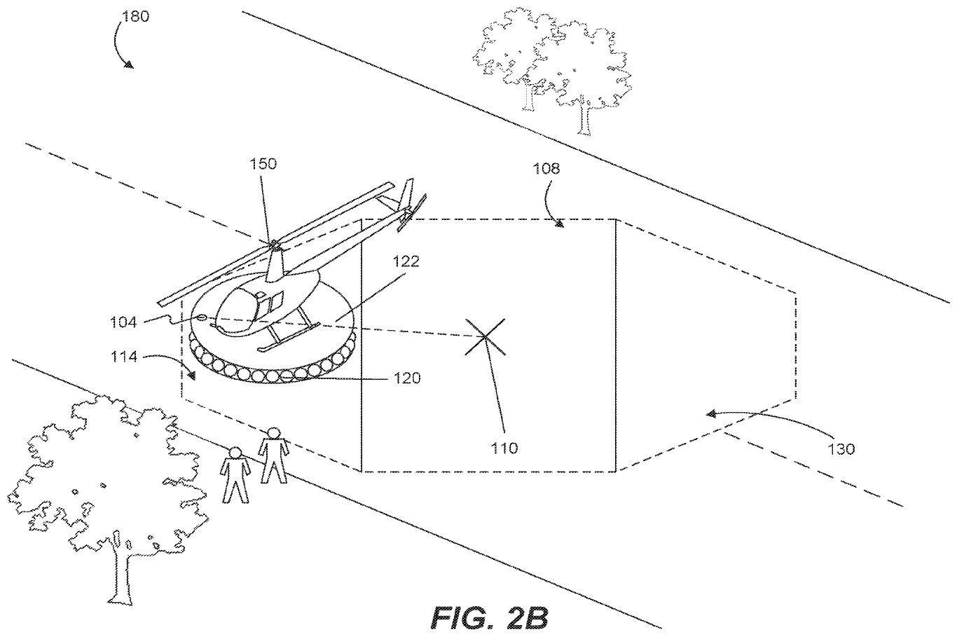

FIG. 2A illustrates an exemplary maneuvering vehicle moving to a location within a parking area, consistent with disclosed embodiments. FIG. 2A illustrates an exemplary maneuvering vehicle 102 moving to a location within a parking area 114. In some embodiments, sensor 104 may be mounted to frame 106 of maneuvering vehicle 102, and may sense parking area 114. Based on the sensing, the one or more processors may determine second location 116 to be the center of parking area 114. In some embodiments, parking area 114 may be the left side of ground 180. Further, FIG. 2A illustrates maneuvering vehicle 102 moving 218 to second location 116. For example, the one or more processors may move 218 maneuvering vehicle 102 by a displacement of ten feet from first location 110 to second location 116. In some embodiments, second location 116 may be based on parking area 114.

In some embodiments, the one or more processors may move 218 the maneuvering vehicle 102 to the determined second location 116. For example, the one or more processors may move the maneuvering vehicle 102 by a displacement of ten feet from a landing area 108 to a parking area 114. In some embodiments, the maneuvering vehicle 102 cam move to the determined second location 116 for permanent storage, temporary storage, or to make room for other aircrafts landing on other maneuvering vehicles. In this way, the maneuvering vehicle 102 may move from a first location 110 (e.g., a location within an aircraft landing area) to the second location 116 (e.g., a location within the parking area). In some embodiments, the parking area 114 may be on the opposite side of a tarmac from the aircraft landing area 108. Alternatively, the parking area 114 and landing area 108 may be the same area. The parking area 114 and the aircraft landing area 108 may share some area. In this way, maneuvering vehicles may be moved to locations included within the landing area 108 and then moved to locations included within the parking area 114 so that multiple aircrafts can land on a non-cluttered tarmac or runway. In some embodiments, the maneuvering vehicle 102 can move to or from a location where the passengers and/or cargo can be loaded and/or unloaded. In some embodiments, the maneuvering vehicle 102 can move to or from a location for battery charging. In some embodiments, the maneuvering vehicle 102 can move to or from a location for cleaning. In some embodiments, the maneuvering vehicle 102 can move to or from a location for inspection or maintenance.

In some embodiments, the maneuvering vehicle 102 may comprise a power source, configured to power the maneuvering vehicle. Power source may refer to a place or thing which energy comes or can be obtained from. Power may refer to supplying an object with energy. Non-limiting examples of power source may include a battery, a generator, an alternator, or an auxiliary power unit. In some embodiments, the maneuvering vehicle 102 may include a storage area for power sources, such as charged batteries. In some embodiments, power source of the aircraft 150 may be swappable or hot-swappable, to reduce downtime of the aircraft 150.

FIG. 2B illustrates an exemplary maneuvering vehicle at a location within a parking area, consistent with disclosed embodiments. FIG. 2B illustrates maneuvering vehicle 102 at second location 116. In this manner, maneuvering vehicle 102 moved 218 to second location 116 because it is the center of parking area 114.

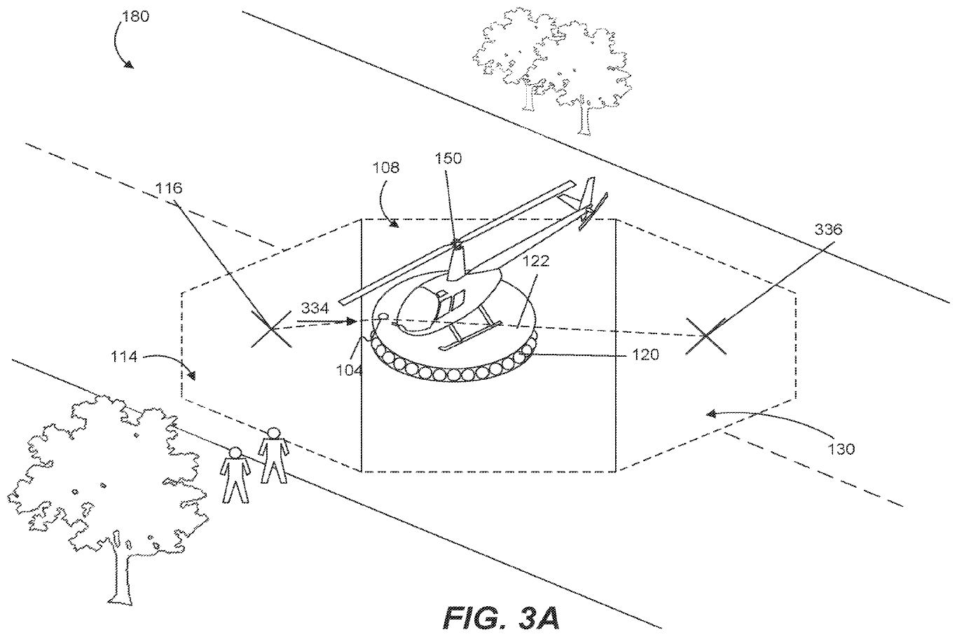

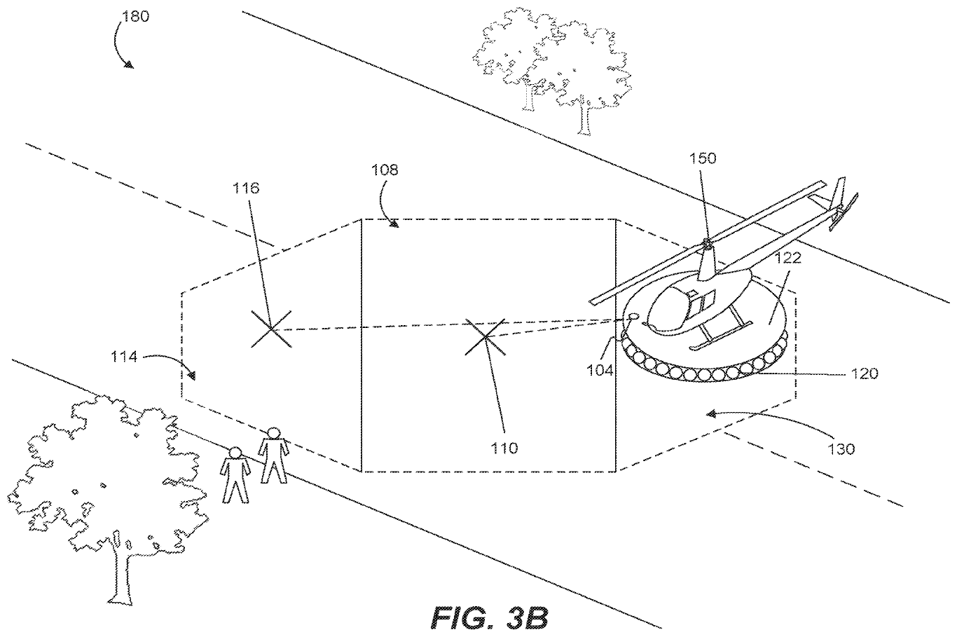

FIG. 3A illustrates an exemplary maneuvering vehicle moving to a location within a takeoff area, consistent with disclosed embodiments. FIG. 3A illustrates an exemplary parking area 114, second location 116, takeoff area 130, and third location 336. In some embodiments, sensor 104 may be mounted to frame 106 of maneuvering vehicle 102, and may sense takeoff area 130. The one or more processors may then determine third location 336 to be the center of takeoff area 130. Takeoff area 130 may be the right side of ground 180. Further, FIG. 3A illustrates maneuvering vehicle 102 moving 334 to third location 336. For example, the one or more processors may move 334 maneuvering vehicle 102 by a displacement of twenty feet from second location 116 to third location 336. In some embodiments, third location 336 may be based on takeoff area 130.

In some embodiments, the one or more processors may be configured to determine a third location 336. In some embodiments, the third location 336 is based on a takeoff area 130. In some examples, the third location may be the first location 110 or the second location 116. Alternatively, the third location 336 may be a location different than the first location 110 and the second location 116. In one example, the third location 336 may be based on either the second location 116 and/or the first location 110. Takeoff area 130 may refer to an area where an aircraft 150 becomes airborne from the maneuvering vehicle 102 or from a pavement or ground surface or similar. In some embodiments, this determination may be made on a sensor 104 sensing the takeoff area 130 as a right side of a tarmac. The one or more processors may then determine the third location 336 to be the center location of the takeoff area 130. Additionally, the one or more processors may be configured to move the maneuvering vehicle 102 to the determined third location 336. For example, the one or more processors may move the maneuvering vehicle 102 by a displacement of twenty feet from a parking area at a second location to the third location in the takeoff area 130.

FIG. 3B illustrates an exemplary maneuvering vehicle moving at a location within a takeoff area, consistent with disclosed embodiments. FIG. 3B illustrates maneuvering vehicle 102 at third location 334. In this manner, maneuvering vehicle 102 moved 334 to third location 336 because it is the center of takeoff area 130.

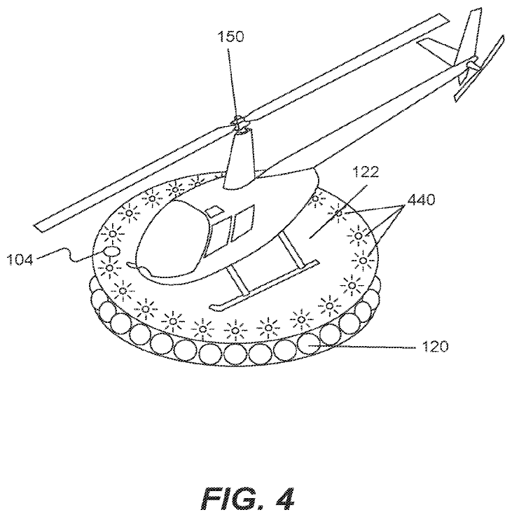

FIG. 4 illustrates an exemplary maneuvering vehicle with navigation features, consistent with disclosed embodiments. FIG. 4 illustrates an exemplary maneuvering vehicle 102 including navigation features 440. In some embodiments, maneuvering vehicle 102 may include navigation features 440. For example, navigation features 440 may be lights to help or aid in aircraft 150 navigation, aircraft 150 takeoff, and/or aircraft 150 landing. In some embodiments, landing platform 122 may include load cells for weight detection, and/or retractable stabilizing legs for leveling and supporting the aircraft 150 when stationary. In some embodiments, the maneuvering vehicle 102 may deploy retractable stabilizing legs to level the platform 122.

In some embodiments, the navigation features 440 may include navigation features configured to aid the landing aircraft 150. Non-limiting examples of navigation features may include passive navigation features, active navigation features, or active navigational guidance features. For example, a maneuvering vehicle 102 may include one or more of a marker, a beacon, a visual aid, a checkerboard, or any other similar characteristics to aid or help in aircraft navigation, aircraft takeoff, and/or aircraft landing.

In some embodiments, navigation features 440 may be passive. Passive navigation features may refer to elements, objects, or devices that are not powered or objects that are configured to relay or reflect a signal. Non-limiting examples of passive navigation features may include one or more of a visual fiducial marker, a multispectral reflective paint, a radar reflector cube, and a lidar reflector cube. For example, the maneuvering vehicle 102 may include radar or lidar reflector cubes, used to reflect electromagnetic waves emitted by radar, such as near or on corners or edges of the landing platform or around the perimeter of the landing platform to help aid the aircraft in landing. As another example, the maneuvering vehicle 102 may include a visual fiducial marker to provide a point of reference, for example, for a predetermined area of the maneuvering vehicle 102 such as its center.

In some embodiments, navigation features 440 may be active. Active navigational features may refer to elements, objects, or devices configured to produce a signal. Non-limiting examples of active navigation features may include visual and an infrared optical beacon with encoded information and a radio frequency beacon with encoded information. For example, the maneuvering vehicle 102 may include radio frequency beacons, used to determine aircraft locations based on the known direction and distance to the radio frequency beacons, such as on edges or corners of the landing platform or around the perimeter of the landing platform 122 to help aid the aircraft 150 in landing.

In some examples, navigation features 440 may include active navigational guidance systems. Active navigational guidance systems may utilize wireless communications to relay information to an aircraft 150. Non-limiting examples of active navigational guidance systems may include real-time kinematic positioning base stations, Global Positioning System (GPS), cellular networks, radar sensors, or lidar sensors, and radio frequency-based time of flight ranging sensors. For example, the system may include radio frequency-based time of flight ranging sensors which use a continuous wave source to modulate or pulse a light or laser to create a unique signal pattern for the aircraft's receiver to help aid in landing.

Different navigational features may be used at different times in the landing process, or multiple navigational features may be used simultaneously. For example, an active navigational guidance system may be used by the aircraft 150 to approach the maneuvering system 102 at a greater distance and a passive navigational feature may be used by the aircraft 150, in addition to the active navigational guidance system, to approach the maneuvering system at a lesser distance. As some examples, navigational features may be used when the aircraft 150 is close to aid in one or more sensors detecting a portion of the maneuvering vehicle 102, such as a perimeter, with more precision than when the aircraft 150 was further away.

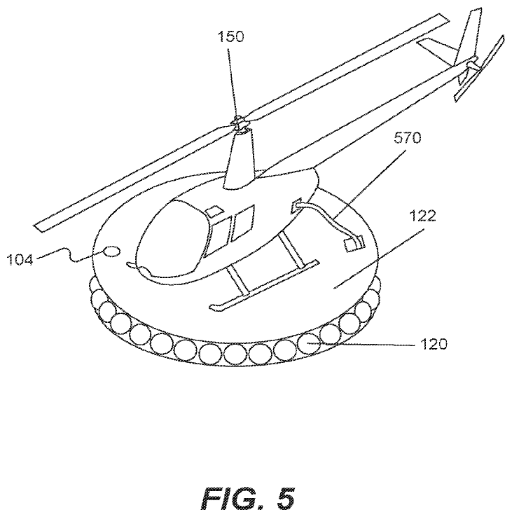

FIG. 5 illustrates an exemplary maneuvering vehicle, consistent with disclosed embodiments. FIG. 5 illustrates an exemplary maneuvering vehicle 102 comprising sensor 104 and landing platform 122. In some embodiments, maneuvering vehicle 102 may include charging system 570. For example, charging system 570 may include an auxiliary power unit that may be used to provide electricity to aircraft 150 for a propulsion system or for functions other than propulsion. In some embodiments, the charging system 570 may be configured to charge the aircraft 150. Charging system 570 may refer to a battery, motor, or engine giving or providing electricity. Non-limiting examples may include a battery, a generator, an alternator, or an auxiliary power unit. For example, an auxiliary power unit may be used to provide electricity to an aircraft 150 for a propulsion system, for example, for an aircraft 150 with one or more electric motors powered by an aircraft battery, or for functions other than propulsion. In this manner, a cabin of the aircraft 150 may provide air conditioning or lights when on the ground. Functions other than propulsion may include for example HVAC, lights, computer systems, communication systems, or similar. In some embodiments, the maneuvering vehicle 102 may be configured to provide charging for an aircraft propulsion system, support (e.g., HVAC, electricity, data transfer, battery cooling), or charging for functions other than propulsion while the maneuvering vehicle is in motion. In some embodiments, the HVAC may include a forced recirculating cooling/heating system for preconditioning and/or thermal management of the aircraft cabin during charging. In some embodiments, the maneuvering vehicle 102 may comprise a power source, configured to power the maneuvering vehicle. Power source may refer to a place or thing which energy comes or can be obtained from. Power may refer to supplying an object with energy. Non-limiting examples of power source may include a battery, a generator, an alternator, or an auxiliary power unit. In some embodiments, the maneuvering vehicle 102 may include a storage area for power sources, such as charged batteries. In some embodiments, power source of the aircraft 150 may be swappable or hot-swappable, to reduce downtime of the aircraft 150.

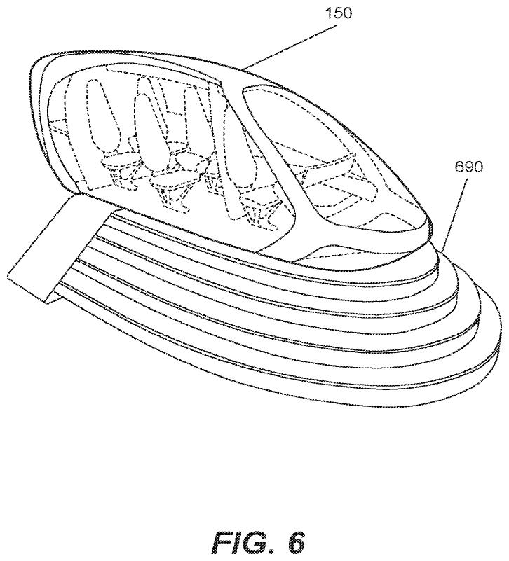

FIG. 6 illustrates an exemplary ground maneuvering system, consistent with disclosed embodiments. FIG. 6 illustrates an exemplary aircraft 150 and receiving stair 690. In this example, receiving stair 690 may also include ramp 694. Receiving stair 690 and ramp 694 may be used together, or independently, as a loading and unloading platform or as part of a disembarking system. For example, a maneuvering vehicle 102 comprising receiving stair 690, passengers or cargo of aircraft 150 may enter and exit via receiving stair 690. In some embodiments, a maneuvering vehicle 102 comprising ramp 694, passengers or cargo of aircraft 150 may enter and exit via ramp 694. In some embodiments, cargo may be loaded or unloaded via ramp 694 and passengers via receiving stair 690. In some embodiments, ramp 694 may be configured to assist mobility impaired individuals with entering or exiting the aircraft 150. For example, ramp 694 may be configured to accommodate movement of a passenger entering or exiting the aircraft 150 via a wheelchair. In some embodiments, ramp 694 may comprise a conveyor.

In some embodiments, the maneuvering vehicle 102 may include a receiving stair 690 mounted to a frame 106. Receiving stair 690 may refer to a series of steps or flights of steps for passing from one level to another to be given or presented to another object. Non-limiting examples of receiving stair 690 may include one step or multiple steps. In one example, the receiving stair 690 may be ten steps mounted to a frame 160 of the movement system 120. In some embodiments, the maneuvering vehicle 102 may include a receiving ramp 694 mounted to a frame 106.

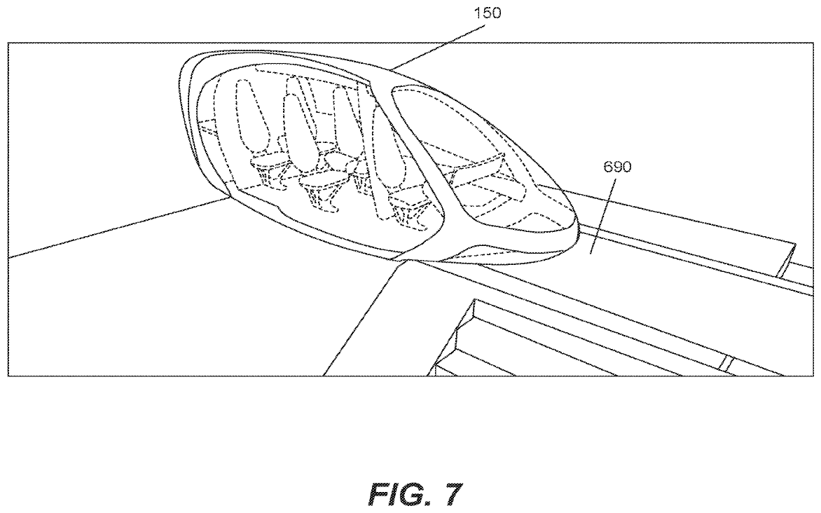

FIG. 7 illustrates an exemplary ground maneuvering system, consistent with disclosed embodiments. FIG. 7 illustrates an exemplary aircraft 150 and receiving vehicle 680. In some embodiments, receiving vehicle 680 includes three steps surrounding aircraft 150 and a ramp 690 to slide cargo down. Receiving vehicle 680 may include a stair 690 and ramp 694, wherein one or more of the stair 690 and ramp 694 move in a direction 792 around and/or towards maneuvering vehicle 102. In some embodiments, the stair 690 and/or ramp 694 may move in direction 792 via an actuator. In this manner, the movement system 120 receiving stair 690 may complement maneuvering vehicle 102 and its frame 106 for efficient landing and takeoff maneuvers. In this example, aircraft 150 may be stationary as receiving vehicle 680 approaches it. Aircraft 150 may be stationary on landing gear (not shown).

One or more sensors of receiving vehicle 680 may sense a position and orientation of aircraft 150 and approach aircraft 150 from a position and an orientation consistent with, for example, one or more of stairs 690 aligning with a door of aircraft 150, a ramp 694 aligning with a cargo bay of aircraft 150, a shape of the maneuvering vehicle 102 aligning with a shape of aircraft 150, a clamp of maneuvering vehicle 102 aligning with a landing gear of aircraft 150, and one or more propulsion charging or auxiliary functions of aircraft 150 aligning with corresponding connections of aircraft 150 (e.g., a charge receiving port for a propulsion of aircraft 150). The one or more sensors may sense a portion of an axle or bolting member on a first side of a wheel and on a second side of a wheel such that an attaching arm of the receiving vehicle 680 may attach to the one or more of the first and second sides in order to two the aircraft 150. In some embodiments, the receiving vehicle 690 may approach such that its attaching arm and/or the vehicle 680 may maneuver to attach to corresponding components of the aircraft 150. In some embodiments, aircraft 150 may comprise one or more of a clamp, a propulsion charging connection, and an auxiliary function connection, where one or more of the clamp, the propulsion charging connection, and the auxiliary function connection may be actuated to mate with a corresponding portion of aircraft 150.

In some embodiments, maneuvering vehicle 102 may include an attachment arm configured to attach to a landing gear of an aircraft 150. Landing gear may refer to the undercarriage of an aircraft 150. The attachment arm may comprise a clamp, a protrusion configured to connect to the aircraft 150, or a receptacle configured to receive a portion of the aircraft 150.

In some embodiments, the sensor 104 may be configured to detect an orientation of a stationary aircraft, wherein a processor is in communication with the sensor 104 and the processor is configured to determine an approach path such that the landing gear aligns with the attachment arm. The processor is configured to send a command to stop the maneuvering vehicle 102 when it contacts the stationary aircraft or when it detects the presence of the stationary aircraft through a sensor. As another example, the processor may be configured to determine an approach path and end position when a door of the aircraft 150 aligns with a receiving stair 690 of maneuvering vehicle 102.

It is contemplated that receiving vehicle 680 can include one or more features of maneuvering vehicle 102. For example, receiving vehicle 680 may be configured to receive aircraft 150, for example on a landing platform (e.g., landing platform 122). As an example, a stair 690 may be configured to assist onloading or offloading from the landing platform (e.g., landing platform 122) to a ground. As another example, a ramp may be configured to assist onloading or offloading from the landing platform (e.g., landing platform 122) to a surface (e.g., a tarmac, a field, a pavement). The receiving vehicle 680 may include a disembarkation system including at least one of a ramp, step, conveyor, or the like. The platform may move to a disembarkation or embarkation position adjacent or near an aircraft. At that point, the maneuvering vehicle may stop and lock its position (e.g., with brakes, one or more stabilizers, chalks, or similar) so the platform may be used for disembarkation and/or embarkation.

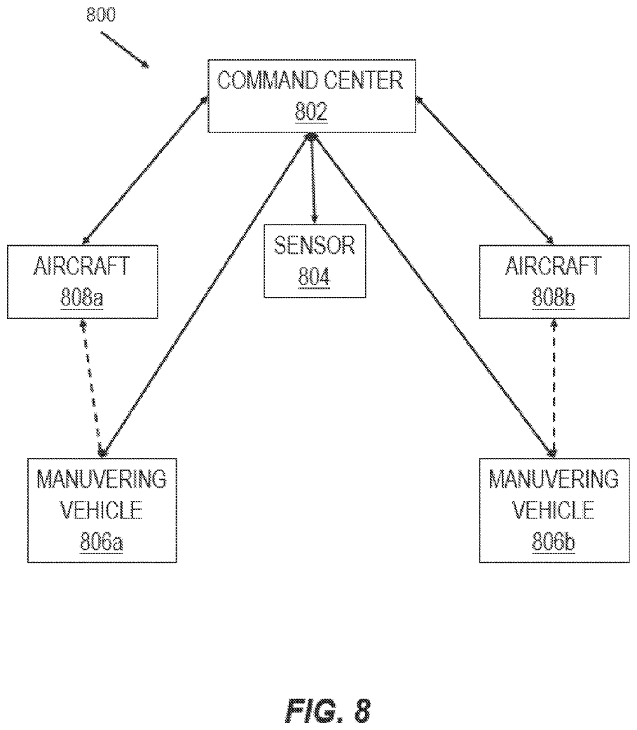

As shown in FIG. 8, an exemplary command system of multiple maneuvering vehicles 800 is illustrated. Command system 800 can include a command center 802 in communication with at least one sensor 804, maneuvering vehicles 806a, 806b, and aircrafts 808a, 808b. Additionally or alternatively, maneuvering vehicles 806a, 806b, may be in communication with aircrafts 808a, 808b, respectively. Command center 802 may include at least one processor configured to execute, send or receive instructions consistent with disclosed embodiments. At least one sensor 804 may be similar to sensor 104 discussed above. One or more sensor 804 may be attached to, or remote from maneuvering vehicles 806a, 806b. Maneuvering vehicles 806a, 806b may be similar to maneuvering vehicles 102 discussed above. Aircrafts 808a, 808b may be similar to aircraft 150 discussed above.

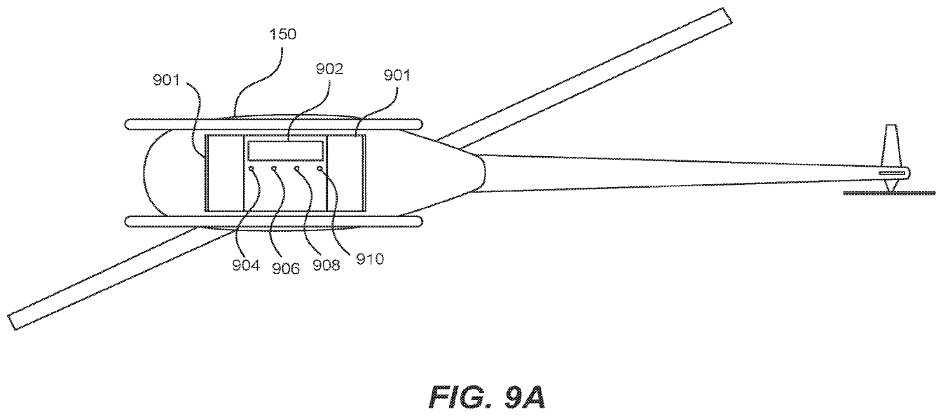

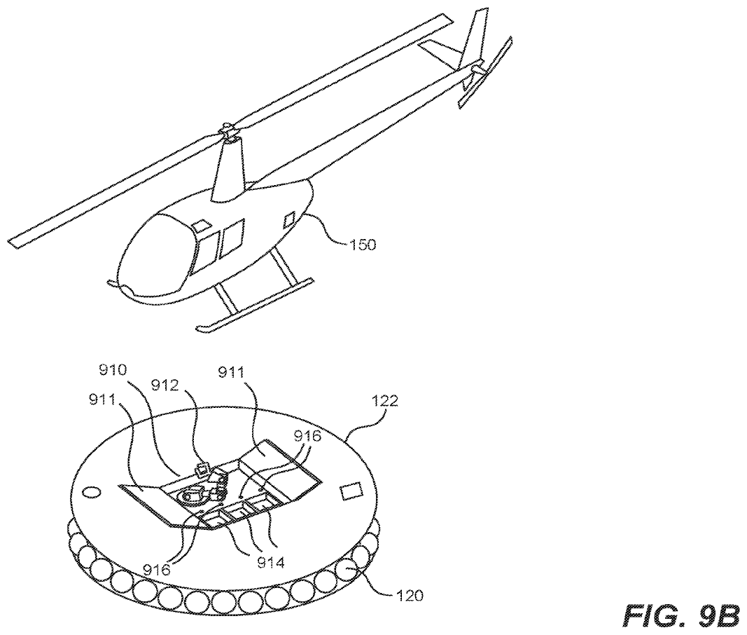

FIG. 9A illustrates an exemplary vehicle, consistent with disclosed embodiments. A vehicle such as aircraft 150, may comprise a compartment with one or more doors 901 or an opening without doors. The vehicle may be configured to open the doors 901 such as through actuators. The doors 901 may slide open and shut, they may move about hinges, or they may otherwise be configured to open to allow access to the compartment. The compartment may comprise one or more of battery slot 902, power connection 904, data connection 906, HVAC connection 908, and auxiliary power connection 910. It will be understood that any other connections are also possible. It will be further understood that the positioning of the compartment is exemplary and the compartment could be located further aft or forward of the vehicle, or the compartment could be on a side of the vehicle. Battery slot 902 may be configured to hold a battery. The battery may be configured to provide a power source to the aircraft, consistent with disclosed embodiments. Battery slot 902 may comprise one or more clips, latches, locks, restraints, or fastener configured to hold a battery within battery slot 902 and keep the battery electrically engaged with the vehicle. The vehicle may be configured to open the door and/or release the battery from battery slot 902. The vehicle may include one or more linear or rotary actuators to open and close the doors. The vehicle may include one or more linear or rotary actuators to release the battery from battery slot 902.

FIG. 9B illustrates an exemplary maneuvering vehicle, consistent with disclosed embodiments. Maneuvering vehicle 120 may include platform 122 consistent with embodiments disclosed herein. Maneuvering vehicle may include a service compartment 910. Maneuvering vehicle 120 may include doors 911 or an opening to access compartment 910. The vehicle 120 may be configured to open the doors 911 such as through actuators. The doors 911 may slide open and shut, they may move about hinges, or they may otherwise be configured to open to allow access to the compartment 910. The compartment 910 may comprise one or more of battery slot or slots 914 and connections 916 that may include power connections, data connections, HVAC connections, and auxiliary power connections. It will be understood that any other connections are also possible. It will be further understood that the positioning of the compartment is exemplary and the compartment could be located on top of the platform 122 at any location. Battery slot or slots 914 may be configured to hold one or more batteries. The batteries may be configured to provide a power source to the aircraft, consistent with disclosed embodiments. Battery slot or slots 914 may comprise one or more clips, latches, locks, restraints, or fastener configured to hold a battery within battery slot 914 and keep the battery electrically engaged with the vehicle 120.

The vehicle 120 may be configured to open the door and/or release the battery from battery slot 914. The vehicle may include one or more linear or rotary actuators to open and close the doors 910. The vehicle may include one or more linear or rotary actuators to release the battery from battery slot 914.

The vehicle 120 may include an arm 912. The arm 912 may include an actuating clamp. The arm 912 may include one or more pivot points to allow the actuating clamp to move from one position to another. The arm 912 may move to be stored under doors 910 when they are closed or within the compartment 910. The arm 912 may be configured to move one or more batteries to/from slot or slots 914 or to/from slot 902 of a vehicle like vehicle 150. The arm 912 may be configured to move one or more cables or other connections to/from connections 916 or connections 904, 906, 908, 910 of a vehicle like vehicle 150.

Consistent with disclosed embodiments, a processor associated with vehicle 120 may be configured to move arm 912 to swap a discharged or depleted battery of vehicle 150 with a charged battery of vehicle 120. Consistent with disclosed embodiments, a processor associated with vehicle 120 may be configured to attach one or more connections to provide services to aircraft 150 from vehicle 120.

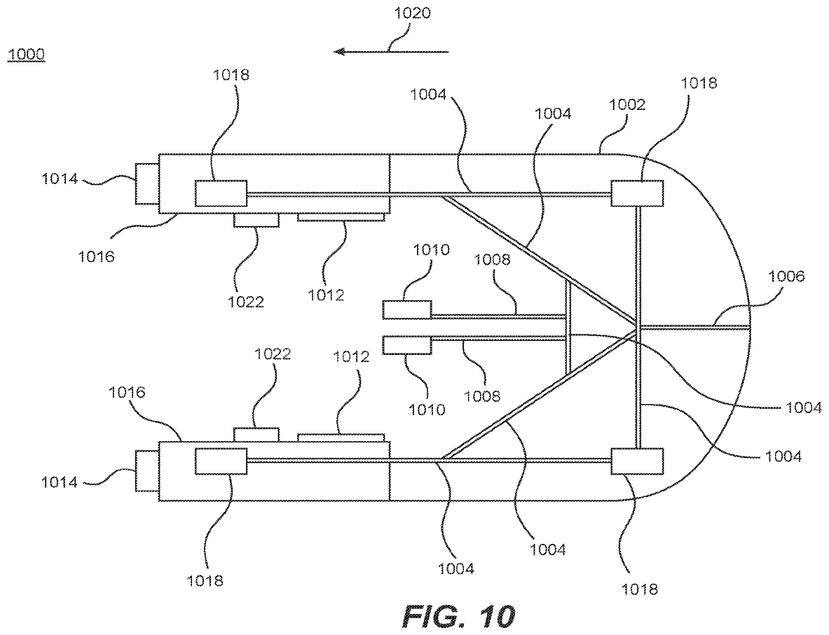

FIG. 10 illustrates a bottom view of an exemplary maneuvering vehicle, consistent with disclosed embodiments. Maneuvering vehicle 1000 may include any features consistent with disclosed embodiments herein. The maneuvering vehicle 1000 may include an outer profile 1002. The maneuvering vehicle 1000 may be a surface to protect internal components of maneuvering vehicle 1000. The outer profile 1002 may be consistent with an outer profile of maneuvering vehicles in FIGS. 6 and 7 or other embodiments disclosed herein. The outer profile 1002 may be consistent with stairs or steps provided on only one side or two sides of a vehicle or aircraft.

The maneuvering vehicle 1000 may include frames 1004. Frames 1004 may be configured to connect wheels 1018 to each other. Frames 1004 may be configured to provide support for other components of the maneuvering vehicle that are connected or mounted to the maneuvering vehicle. Frames 1004 may include an axle between front wheels 1018 of the vehicle. Frames 1004 may include a triangular frame to support parallel side of the vehicle. Frames 1004 may be configured to provide space within the vehicle for a portion of a vehicle or aircraft such as aircraft 150. Frames 1004 may be configured to provide space within the vehicle for one or more wheels of a vehicle or aircraft such as aircraft 150.

The maneuvering vehicle 1000 may comprise profile supports 1006. Profile supports 1006 may be configured to maintain a structure of the outer profile 1002.

The maneuvering vehicle 1000 may comprise one or more attachment arms 1008. Attachment arms 1008 may be configured to provide support for clamps 1010. Attachment arm 1008 may be configured to move to attach to one or more wheels of a vehicle such as aircraft 150. For example, attachment arms 1008 may be configured to move locally within the maneuvering vehicle such as pivoting or moving in or away from direction 1020. Attachment arms 1008 may include one or more actuators. Attachment arms 1008 may be configured to pivot at a connection with frames 1004. Attachment arms 1008 may include a telescoping rod or tubing. Attachment arms 1008 may be configured to provide support for lifting an aircraft.

The maneuvering vehicle may comprise one or more clamps 1010. Clamps 1010 may be configured to clamp a vehicle or aircraft such as aircraft 150. Clamps 1010 may be configured to clamp onto an axle of a wheel of a vehicle or aircraft 150 to allow the wheel to rotate or clamp 1010 may be configured to clamp onto and lift the wheel to allow the vehicle or aircraft to move.

The maneuvering vehicle 1000 may comprise one or more compartments 1012. The one or more compartments 1012 may include any features of compartment 910 with or without doors 911 as discussed with reference to FIG. 9B. The one or more compartments 1012 may be configured to service an aircraft or vehicle partially within maneuvering vehicle 1000.

The maneuvering vehicle 1000 may comprise one or more sensors 1022. The sensors 1012 may be configured to determine a position of a vehicle or aircraft such as aircraft 150 within a space defined by one or more of the frames 1004 and outer profile 1002. Sensors 1022 may include a distance sensor. Sensors 1022 may be a sensor consistent with disclosed embodiments. A processor of the maneuvering vehicle may be configured to compare a distance sensed by each of sensors 1022 to determine if a vehicle or aircraft such as aircraft 150 is centered within the maneuvering vehicle 1000. Sensors may be mounted on inside surfaces 1016 or on frames 1004 or any other surface of the maneuvering vehicle 1000.

The maneuvering vehicle 1000 may include sensors 1014. Sensors 1014 may face in direction 1020. Sensors 1014 may be configured to determine a position of one or more wheels of a vehicle or aircraft such as aircraft 150. Sensors 1014 may include a distance sensor. Sensors 1014 may be a sensor consistent with disclosed embodiments. A processor of the maneuvering vehicle 1000 may be configured to compare distance information from sensors 1014 to determine a relative position of the vehicle or aircraft relative to maneuvering vehicle 1000 or an aft surface of maneuvering vehicle 1000.

The maneuvering vehicle 1000 may comprise wheels 1018. Wheels towards an aft of maneuvering vehicle 1000 (in direction 1020) may be caster wheels. Wheels towards a fore of maneuvering vehicle 1000 (away from direction 1020) may be driven and directional wheels. For example, the fore wheels may be configured to steer maneuvering vehicle 1020 and/or be driven by a motor to move maneuvering vehicle 1000. Maneuvering vehicle 1000 may include any other movement system consistent with disclosed embodiments.

A processor of the maneuvering vehicle 1000 may determine to move to attach to a vehicle or aircraft such as aircraft 150 based on the position of the vehicle or aircraft, consistent with disclosed embodiments. The maneuvering vehicle 1000 may be configured to move in direction 1020 to attach to a wheel of the vehicle or aircraft. The maneuvering vehicle 1000 may be configured to move opposite of direction 1020 to carry or move the vehicle or aircraft to a different location, consistent with disclosed embodiments. For example, the processor may determine to move to attach to the vehicle or aircraft, attach to the vehicle or aircraft via clamps 1010, and then move to the different location. The processor of the maneuvering vehicle 1000 may be configured to move to a stopped vehicle or aircraft based on feedback from sensors 1014 and/or sensors 1016 that report a position of the stopped vehicle. The processor may be configured to rely on information from sensors 1014 to move closer to the stopped aircraft, and then rely on information from sensors 1022 to move to attach clamps 1010 to a portion of the stopped aircraft.

For example, a first maneuvering vehicle may receive a first aircraft and a second maneuvering vehicle may move a second aircraft to a parking area. It is contemplated that a main control center may direct the maneuvering vehicles to move to a determined area. For example, the main control center may determine via sensor that a parking area is open and direct the maneuvering vehicle to move to the parking area. As another example, the main control center may determine that an aircraft has taken off and that an associated maneuvering vehicle may move to a standby area or a parking area, until a new aircraft requires assistance. In some embodiments, the main control center may send and receive signals from one or more maneuvering vehicles to coordinate movement of the maneuvering vehicles. In some embodiments, the main control center may receive signals from one or more maneuvering vehicles and/or aircraft to determine whether a particular maneuvering vehicle or aircraft has a predetermined threshold of charge.

It is to be understood that the configuration and boundaries of the functional building blocks of the monitoring system have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It will be apparent to persons skilled in the art that various modifications and variations can be made to disclosed ground maneuvering systems for aircraft. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A ground maneuvering system comprising:
at least one maneuvering vehicle comprising:
at least one processor in communication with at least one sensor, the one or more processors configured to:
sense, using the one or more sensors, an area associated with a plurality of areas;
determine a location within the area;
determine a path for the maneuvering vehicle to move to the location; and
maneuver the maneuvering vehicle to the location;
a propulsor configured to move the maneuvering vehicle in or around the plurality of areas; and
a platform configured for an aircraft.

2. The ground maneuvering system of claim 1, further comprising a navigation feature, the navigation feature including at least one of: a marker, a reflector, a reflective paint, a beacon, or a wireless communication system, wherein the navigation feature is configured to aid the aircraft in landing.

3. The ground maneuvering system of claim 1, wherein the maneuvering vehicle further comprising a charging system, wherein the charging system is configured to charge the aircraft.

4. The ground maneuvering system of claim 1, wherein the location is a first location within the area, the area is a first area, and the one or more processors further configured to:
responsive to the aircraft landing on the platform, sense a second area;
determine a second location within the second area; and
maneuver the maneuvering vehicle to the second location.

5. The ground maneuvering system of claim 1, wherein the determination of the location is based on a flight trajectory of the aircraft.

6. The ground maneuvering system of claim 1, further comprising:
an attachment arm configured to attach to a landing gear of the aircraft; and
wherein the one or more sensors are configured to determine whether the attachment arm has attached to the landing gear.

7. The ground maneuvering system of claim 1, wherein the maneuvering vehicle is in communication with the aircraft and configured to send or receive telemetry data with the aircraft.

8. The ground maneuvering system of claim 1, wherein the maneuvering vehicle is in communication with a ground maneuvering command center and configured to send or receive data with the ground maneuvering command center.

9. The ground maneuvering system of claim 1, wherein the maneuvering vehicle includes one or more of: a ramp, a step, conveyor.

10. A ground maneuvering system comprising:
at least one processor associated with a ground maneuvering command center in communication with at least one sensor and at least one maneuvering vehicle, the at least one processor configured to:
sense, using the at least one sensor, a position of the at least one maneuvering vehicle relative to an area;
determine a location within the area;
determine a path for the maneuvering vehicle to move to the location; and
transmit, to the at least one maneuvering vehicle, instructions to maneuver to the location.

11. The ground maneuvering system of claim 10, wherein the determination of the location is based on a flight trajectory of the aircraft.

12. The ground maneuvering system of claim 10, wherein the at least one maneuvering vehicle includes:
one or more processors in communication with one or more sensors, the one or more processors configured to send or receive instructions with the ground maneuvering command center;
a propulsor configured to move the maneuvering vehicle in or around a plurality of areas; and
a platform configured for an aircraft.

13. The ground maneuvering system of claim 12, further comprising a navigation feature, the navigation feature including at least one of: a marker, a reflector, a reflective paint, a beacon, or a wireless communication system, wherein the navigation feature is configured to aid the aircraft in landing.

14. The ground maneuvering system of claim 10, the at least one processor further configured to receive, from the maneuvering vehicle, confirmation of maneuvering to the location.

15. The ground maneuvering system of claim 10, the at least one processor further configured to sense, using the at least one sensor, that the at least one maneuvering vehicle has maneuvered to the location.

16. The ground maneuvering system of claim 10, wherein the location is a first location within the area, the area is a first area, and the at least one processor is further configured to:
responsive to the aircraft landing on the platform, sense a second area;
determine a second location within the second area; and
transmit, to the at least one maneuvering vehicle, instructions to maneuver to the second location.

17. The ground maneuvering system of claim 10, wherein the maneuvering vehicle includes at least one of: a conveyor, a ramp, or a step.

18. An aircraft movement system comprising:
at least one receiving vehicle including:
a propulsor configured to move the vehicle;
a disembarkation system including one or more of a ramp, step, or conveyor, wherein the vehicle is configured to move to mate the disembarkation system to one or more surfaces of an aircraft;
a sensor configured to determine whether the disembarkation system is mated against the vehicle and configured to detect an orientation of a stationary aircraft; and
a processor in communication with the sensor, wherein the processor is configured to determine an approach path of the vehicle so that an attachment arm aligns with a landing gear of the aircraft.

19. The system of claim 18, wherein the disembarkation system is further configured to be on both sides of the aircraft to accommodate loading and unloading from both sides of the aircraft.

20. The system of claim 18, wherein the maneuvering vehicle is configured to brake the vehicle and the aircraft.
